(19) United States
(12) Patent Application Publication
(10) Pub. No.: US 2007/0210241 A1
(43) Pub. Date: Sep. 13, 2007

(54) Light detector

(76) Inventors: Brett C. Greenwalt, Arlington, VA (US); Xinnakone Sung Vivathana, Manchester, NH (US)

Correspondence Address: LITMAN LAW OFFICES, LTD., P.O. BOX 15035, CRYSTAL CITY STATION, ARLINGTON, VA, 22215, US

(21) Appl. No.: 11/706,314

(22) Filed: Feb. 15, 2007

Related U.S. Application Data
(60) Provisional application No. 60/779,469, filed on Mar. 7, 2006.

(51) Int. Cl. H05B 37/02

(52) U.S. Cl. 250/214 AL

(57) ABSTRACT

The light detector is a light meter having a processor receiving a signal from a photoelectric device. The processor compares the signal to a lower threshold of a user-selectable light intensity range to determine if the signal is greater than or equal to the lower threshold. If the signal is greater than or equal to the lower threshold, a timing counter counts. If the signal falls below the lower threshold of the user selected range, the timing counter is inhibited from counting. For any given period of use, the amount of time that light is at or above the lower threshold is recorded and displayed. Alternatively, lower and upper thresholds are used to limit timing to a user specified light intensity range. Counter and light intensity data are stored in processor memory and can be wirelessly transmitted via an on-board wireless transmitter to a receiving station.

### CROSS-REFERENCE TO RELATED APPLICATION

This application claims the benefit of U.S. Provisional Patent Application Ser. No. 60/779,469, filed Mar. 7, 2006, which is hereby incorporated by reference in its entirety.

### BACKGROUND OF THE INVENTION

1. Field of the Invention

The present invention relates to measuring devices utilized to measure and record the amount of time that a light having its light output within a user selected detection range strikes a detection sensor, and more particularity to a light detector that provides a user with the capability to determine whether and for how long a specific environment has received light having an output that falls within user-selected light intensity parameters.

2. Description of the Related Art

There are many activities in which it is necessary or useful to know the level of light available at a given location. For example, gardeners need to know whether a given location has adequate exposure to light over a given time period during the day to support growth of certain plants or crops. Likewise, photographers need to know ambient or artificial light levels at particular locations in order to set the proper exposure for either still photography or for video cameras.

For some of these activities, a qualitative estimate of light levels by the naked eye is inadequate, and a quantitative measure of the intensity of light is required. Thus, a light detector solving the aforementioned problems is desired.

### SUMMARY OF THE INVENTION

The light detector is a light meter having a processor receiving a signal from a photoelectric device. The processor compares the signal to a lower threshold of a user selectable light intensity range to determine if the signal is greater than or equal to the lower threshold. If the signal is greater than or equal to the lower threshold, a timing counter counts. If the signal falls below the lower threshold of the user-selected range, the timing counter is inhibited from counting. For any given period of use, the amount of time that light is at or above the lower threshold is recorded and displayed.

Alternatively, a lower and an upper threshold may be used for comparison by the processor so that light that either falls below the lower threshold or exceeds an upper threshold of the range inhibits the timing counter from counting. Counter and light intensity data are stored in processor memory and can be wirelessly transmitted via an on-board wireless transmitter to a receiving station.

These and other features of the present invention will become readily apparent upon further review of the following specification and drawings.

### BRIEF DESCRIPTION OF THE DRAWINGS

FIGS. 1A, 1B and 1C show an overall electrical schematic diagram of a light detector according to the present invention.

FIGS. 1D, 1E, 1F, 1G and 1H show flowcharts of low level operations of the light detector according to the present invention.

FIGS. 2A, 2B and 2C show an electrical schematic diagram of a control logic and display driver circuit for an alternative embodiment of a light detector according to the present invention.

FIG. 3 is an electrical schematic diagram of a timer/counter circuit of the light detector of FIGS. 2A-2C according to the present invention.

FIG. 4 is a timing diagram of the light detector of FIGS. 2A-2C according to the present invention.

FIG. 5 is an electrical schematic diagram of a driver-display circuit of the light detector of FIGS. 2A-2C according to the present invention.

FIG. 6 is an electrical schematic diagram including the input for driving the driver-display circuit of the light detector of FIGS. 2A-2C according to the present invention.

FIG. 7 is an electrical schematic diagram showing the driver topology of the light detector of FIGS. 2A-2C according to the present invention.

FIG. 8 is an electrical schematic diagram showing a window comparator output of the light detector of FIGS., 2A-2C according to the present invention.

FIG. 9 is an electrical schematic diagram of a control signal feeding the window comparator of the light detector of FIGS. 2A-2C according to the present invention.

FIG. 10 is an electrical schematic diagram of the control voltage circuitry for the light detector of FIGS. 2A-2C according to the present invention.

Similar reference characters denote corresponding features consistently throughout the attached drawings.

### DETAILED DESCRIPTION OF THE PREFERRED EMBODIMENTS

The present invention is a light detector having a processor receiving a signal from a photoelectric device. The processor compares the signal to a lower threshold of a user selectable light intensity range to determine if the signal is greater than or equal to the lower threshold.

If the signal is greater than or equal to the lower threshold, a timing counter counts. If the signal falls below the lower threshold of the user-selected range, the timing counter is inhibited from counting. For any given period of use, the amount of time that light incident the device is at or above the lower threshold is recorded and displayed.

Alternatively, a lower and an upper threshold may be used for comparison by the processor so that light that either falls below the lower threshold or exceeds an upper threshold of the range inhibits the timing counter from counting. Counter and light intensity data are stored in processor memory and can be wirelessly transmitted via an on-board wireless transmitter to a receiving station. The real-time light detector, with its functionality, provides the end user with an instrument to detect the intensity of light in a given area. It also introduces a feature where the user can choose a certain light intensity to be timed throughout the course of a day. This is beneficial because the user can set the real-time light detector in a given area and come back hours later and be able to determine the amount of light available in that particular area. The light detector can be used for various applications including, but not limited to, gardening and a photo studio. Since the light detector displays its reading in real-time, it becomes beneficial to the user in terms of ease of use as well as being time efficient. The real-time light detector is to be used in areas where light strength is needed to be measured and/or determined. Such places would be in a garden or photo studio.

Since the human eye cannot distinguish the differences in unit of light intensity (LUX), the light detector described herein produces a single digit display to allow the user to determine how much light intensity there is in a given area. The particular area of use for the real-time light detector is defined as any fixed area exposed to light, direct or indirect, ranging from a couple of square feet to several hundred square feet. Its main function is to help determine any variable obstruction of light that may occur throughout the course of a day or time period. Such obstructions can be trees, homes (due to Earth's rotation), clouds, etc. Once the intensity of light is given, the user can then determine whether it is feasible to plant a flower or take a picture.

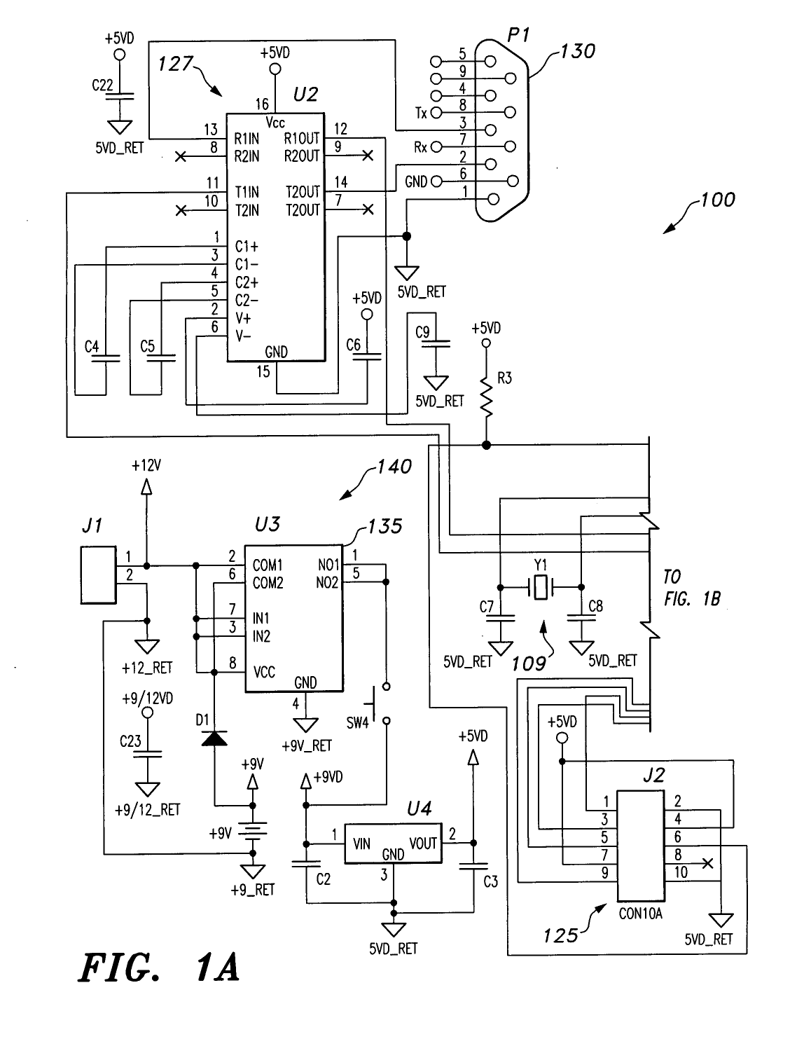

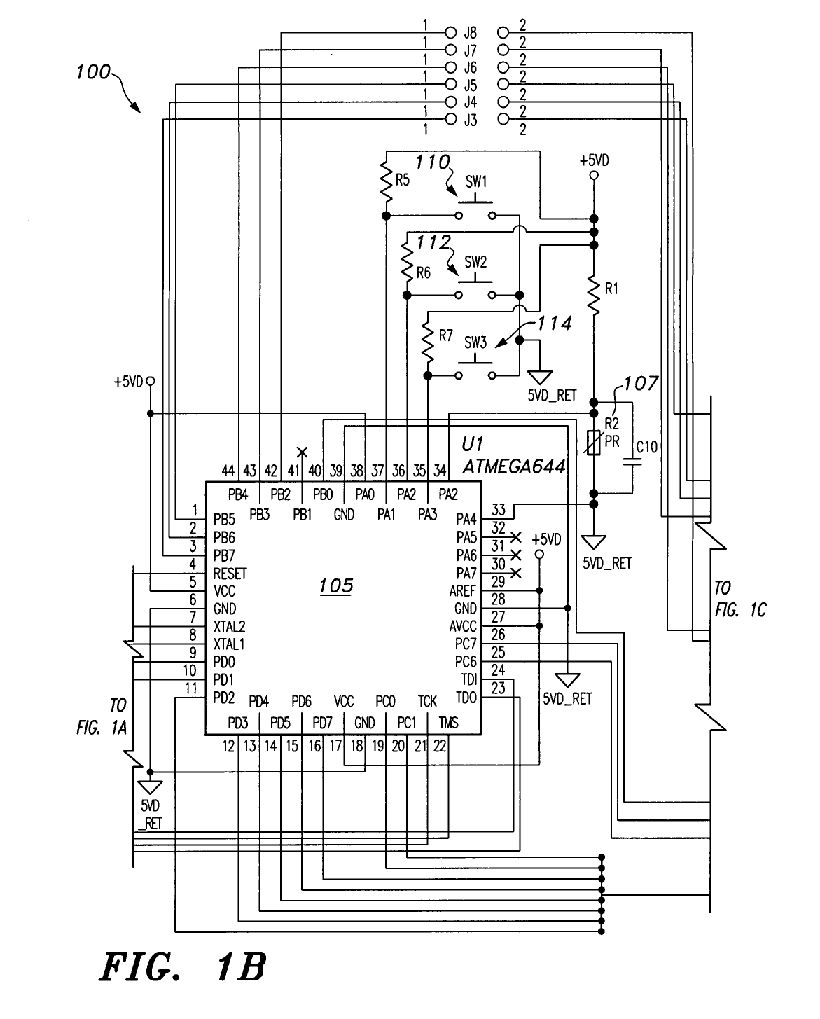

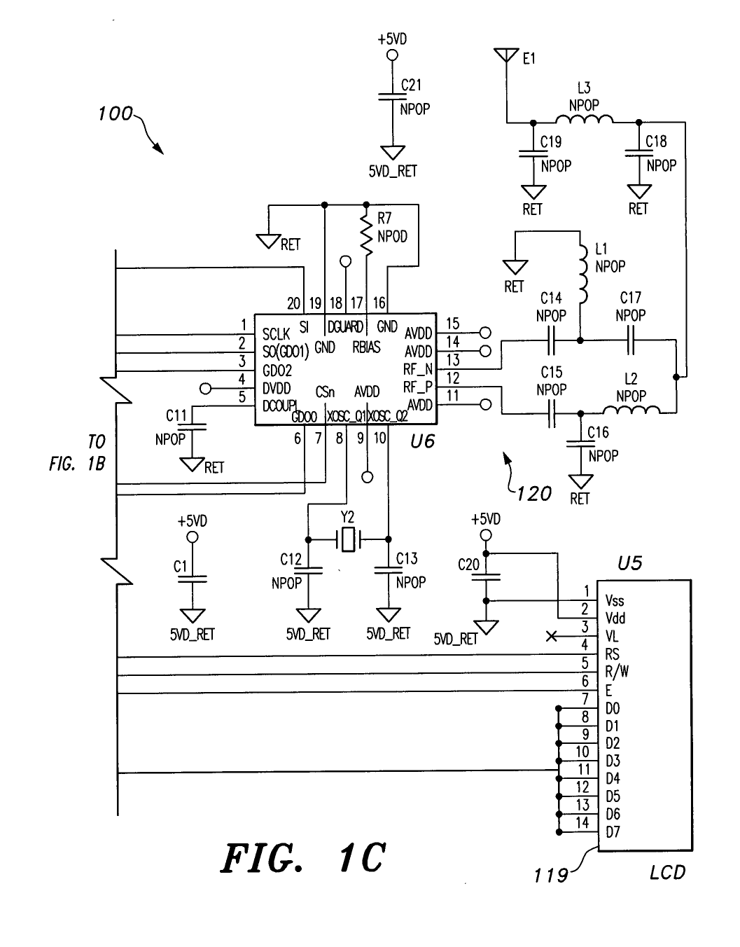

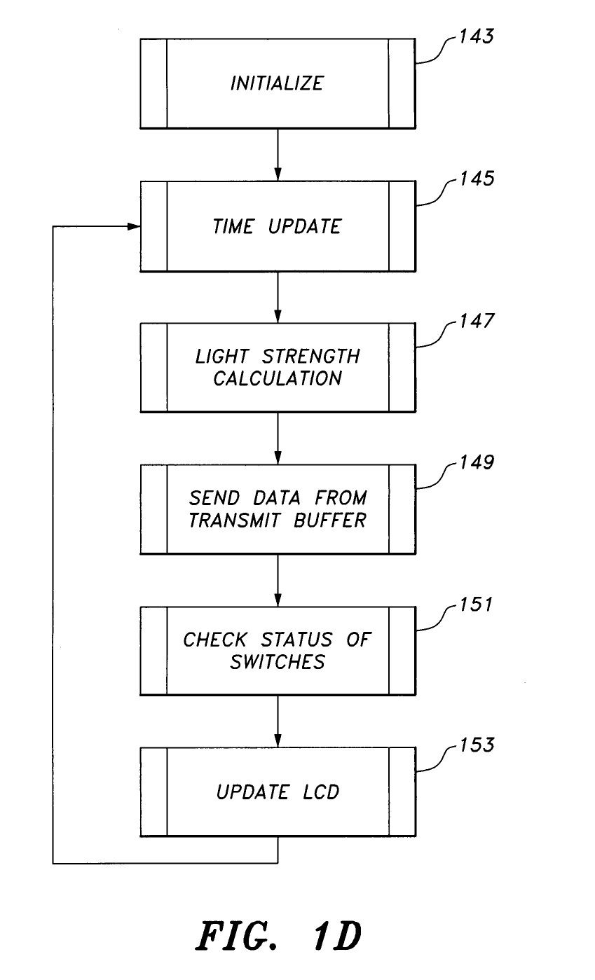

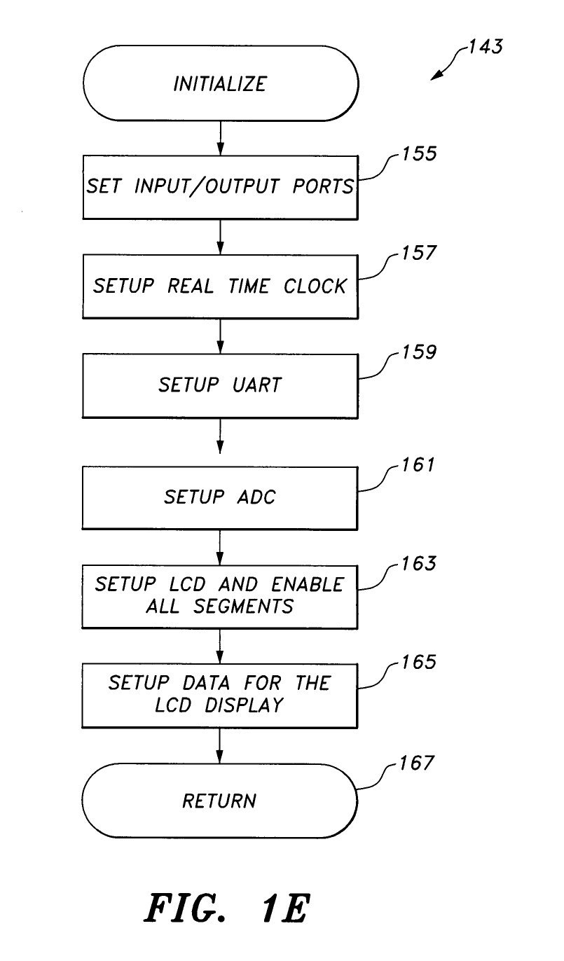

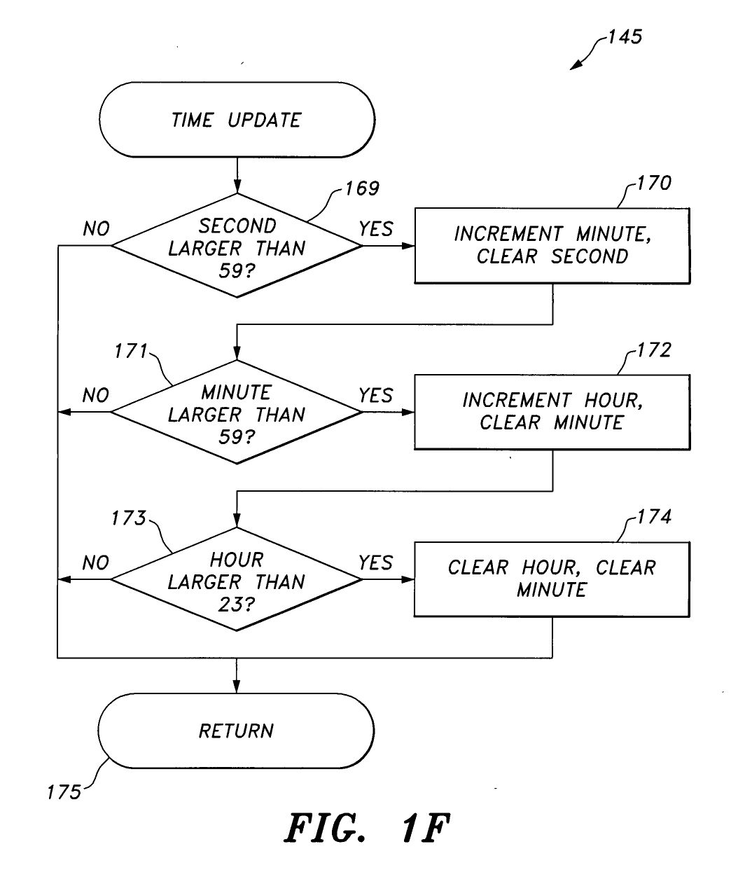

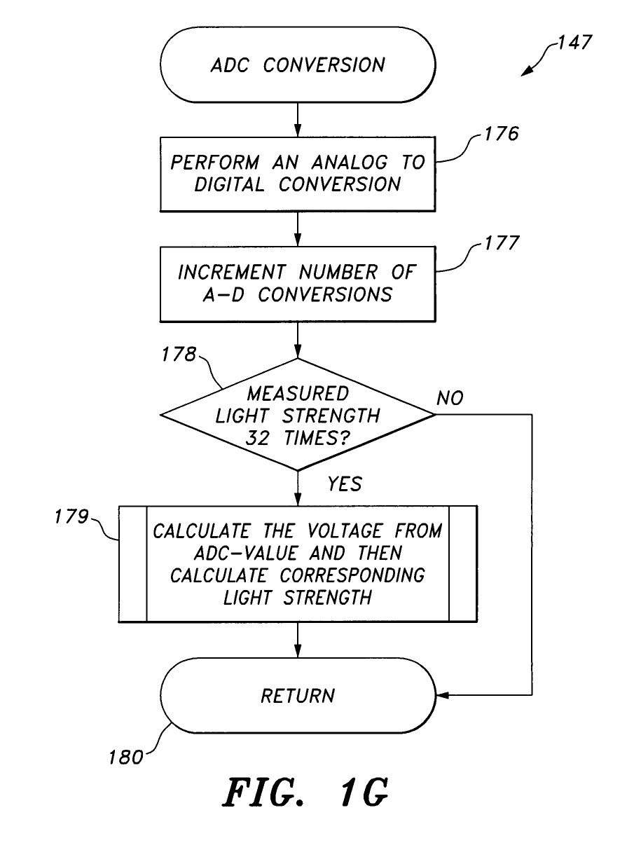

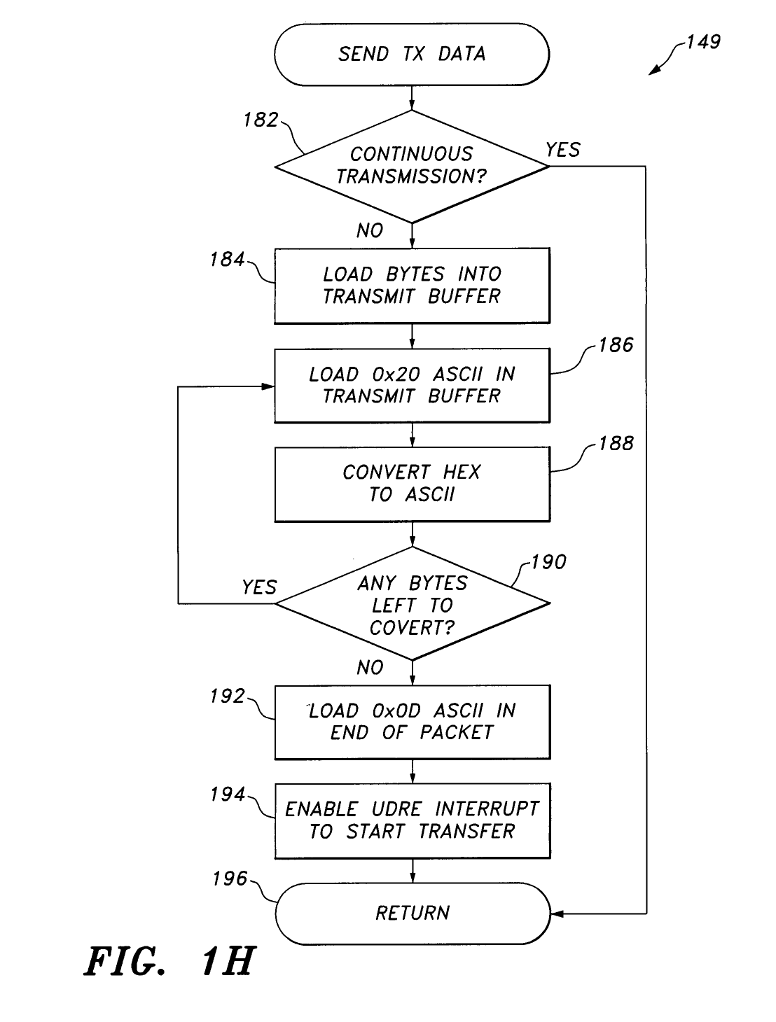

FIGS. 1A-1C show an overall electrical schematic diagram of the electrical circuitry of light detector 100.

A driver/display 119 is in operable communication with processor 105. Preferably, processor 105 is capable of performing all the communication, analog-to-digital conversions, and data functions described herein. The driver/display 119 is preferably visible from any housing that may be used to cover circuitry of the light detector 100. The driver/display 119 is preferably a digital, liquid crystal (LCD) system, but may be of any type that is compatible with processor 105.

The processor 105 may be a microprocessor, a microcontroller unit, a programmable logic array, or the like. The processor 105 can receive input from a photoelectric sensor 107, switches 110, 112, and 114, programming interface 125, user interface 130, system clock 109, and a power supply 140. Moreover, the processor 105 is in operable communication with a wireless transceiver system 120 that allows the light detector 100 to send and receive streaming data to/from a remote device over a desired frequency band, such as the Industrial Scientific Medical (ISM) band. Preferably, wireless transceiver system 120 includes a small surface mount antenna E1 for radio frequency propagation/reception. Additionally, the transceiver system 120 may have an internal transmit FIFO, an internal receive FIFO, a modulator, a demodulator and a frequency synthesizer for transmitting and receiving the data to and from the remote device. Universal Serial Asynchronous Receiver-Transmitter (USART) device 127 provides multi-channel, bi-directional communication preferably via RS-232 interface specification with the light detector 100 through the user interface 130. User interface 130 may preferably be a DB9 connector capable of being connected to a user's personal computer or other RS-232 capable device. User interface 130 connection to an external device, such as a PC or the like, allows the user to save data events for any future reference.

The processor 105, being in operable communication with the driver/display 119, is capable of operating display elements of driver display 119. Preferably, the light detector 100 utilizes off-the-shelf components in construction of the circuitry.

The power supply 140 has a 5-volt voltage regulator U4 that maintains a steady voltage source, being driven by a 9-volt battery when switch SW4 is in the “on” position. Preferably switch SW4 is a precision single supply Single Pole Single Throw (SPST) analog switch capable of selecting the power supply input. Additionally, an analog switch 135 is provided that can detect when an AC power adaptor is connected to the mains through J1. When mains power is detected, the analog switch 135 switches the regulator U4 away from the battery source and connects the regulator U4 to the J1 source. Preferably the regulator U4 is a low drop out (LDO) linear regulator defining V_{cc} voltage and control voltage.

Moreover, the power supply 140 can provide a bias voltage for required reference voltages and the photoelectric sensor 107. Preferably photoelectric sensor 107 is a photo resistor or light dependent resistor that can detect light. The photo resistor 107 is provided in a voltage divider circuit functioning as analog input to a preferably 10-bit analog-to digital converter on-board processor 105. Referring to FIG. 1B it should be understood that the analog signal used to drive the microcontroller's analog input is derived from the following equation;

V(PA3_{—}V1)=5V*((R2/(R2+R1). (1)

Switch 110 is provided as a data increment switch. Switch 114 is provided as a data decrement switch. Switches 110 and 114 are preferably momentary switches. Switch 112 is provided as a set/run switch, and is preferably a pushbutton toggle switch. The processor 105 is programmable through the programming connections 125 at jack J2 to input a program, such as the program illustrated by the flow charts of FIGS. 1D-1H.

FIGS. 1D-1H show the preferred flow of logic utilized by the light detector 105 of FIGS. 1A-1C.

The sequence of events starts when the unit 100 is powered on through the on/off switch SW4 that relays the energy, in this case, either the 9V battery or an AC adaptor that preferably inputs 12-volts DC through J1. Processor 105 initializes timer/counter, (preferably a software, firmware, or hardware counter within processor 105) if the switch 112 is set to RUN. The timer/counter can display the time of exposure to light having a strength selected by the user. Conversely, if the switch 112 is set to SET, then the timer/counter will remain in an interrupt service routine until the switch 112 is set to RUN. While in SET mode, the user can choose the strength of light setting by depressing switches 110 and 114. In SET mode, depressing the switch 110 increments the light intensity value and, on the other hand, depressing the switch 114 decrements the light intensity value.

Selectable light intensity values range from 0-5 so that the light detector 100 may operate in real-time to show a real time display of a digital output that ranges from zero (0) to five (5), with zero (0) being the lowest or no amount of light detected and five (5) being the most amount of light detected in a given area. Moreover, the user selectable light intensity ranges are calibrated and scaled in ranges of LUX units. Once the user sets a desired light intensity value and sets the switch 112 to RUN, the processor 105 starts its timing sequence while comparing an analog-to-digital input from the photo resistor 107 to the value selected by the user. That is to say, if the user sets a desired strength of 3, then, at any point in time that the processor 105 “sees” its analog-to-digital input at a scale relative to that strength, it will begin counting time. If the input drops below the strength value of 3, then the micro controller 105 begins an interrupt and maintains the time/count value in a buffer until the input equals or goes above the strength setting. If X=strength set by the user and Y=the real-time light intensity measured by the device 100, while A=perform timing/counting and B=inhibit timing/counting, then the following logic applies and is preferably included in programs residing in the processor 105.

If Y≧X, then A; (2)

If Y<X, then B; (3)

Alternatively the following logic may be programmed in processor 105.

If X₁≦Y≦X₂, then A; (4)

If X₁≦Y≦X₂ then B, (5)

where X₁ is a lower light threshold and X₂ is an upper light threshold.

Furthermore, the user can leave the real-time light detector 100 in a given area over the course of a day so that the user can set the real-time light detector 100 at a particular strength setting, and the unit 100 will count time for a given light strength at or above the user setting. This will allow the user to determine whether there is sufficient light over a period of time to grow a flower or other various plants.

Additionally, the processor 105 sends the data in real time to the on-board liquid crystal display 119. Moreover, the processor 105 is capable of sending data through the RS-232 port 130 for communications with a personal computer. The RS-232 feature allows the user to see the data on a personal computer and save the data for future reference.

In terms of wireless expansion, the processor 105 has a Serial Peripheral Interface (SPI) through which the processor 105 can be connected to the Serial Peripheral Interface of a Radio Frequency transceiver 120. This feature is provided to enable wireless communication of data between light detector 100 and a remote device.

Low level operational logic flow is shown in FIGS. 1D-1H. As shown in FIGS. 1D-1E, an initialization routine 143 may be performed. The initialization routine 143 comprises updating time 145, calculating light strength 147, sending data from a transmit buffer 149, checking the status of switches 151, and updating the LCD 153. During initialization, input/output ports may be set 155, a real-time clock may be setup 157, a UART may be setup 159, an ADC (analog-to-digital converter) may be setup 161, the LCD may be setup with all segments may be enabled 163, and data for the LCD display may be setup 165. After initialization processing 143, processing is returned at step 167 to a main program, routine, or sub-routine.

As shown in FIG. 1F, in the time update function 145, clock time may be incremented according to 24-hour clock modulo rules, as shown in steps 169, 170, 171, 172, 173, and 174. Upon completion the time update function 145 returns 175.

As shown in FIG. 1G, the analog-to-digital conversion (ADC) function 147 performs an analog-to-digital conversion at step 176. At step 177, a counter of A-D conversions is incremented. At step 178 a test is performed to insure that the light strength has been measured thirty-two times before calculating the voltage from the ADC value and calculating the corresponding light strength, as shown at step 179. When ADC processing is completed, step 180 causes a return to the main program.

When data is sent to a PC via the user interface 130, the data is preferably sent in a continuous manner; otherwise, delimiting information is added to the stream, as shown in FIG. 1H. At step 182 a continuous transmission check is performed. For non-continuous transmission, the transmission data (TX data) send function 149 includes loading bytes in a transmit buffer 184, loading a hexadecimal 20₁₆ (space) in the buffer 186, converting hexadecimal to ASCII 188, and repeating the process for all bytes to convert 190. Subsequently, a hexadecimal OD₁₆ (line feed) is loaded at the end of the stream, i.e., the data packet, at step 192. A UDRE (USART Data Register Empty) interrupt is enabled at step 194 to initiate the transfer. The data transmission function returns at step 196 upon completion of processing.

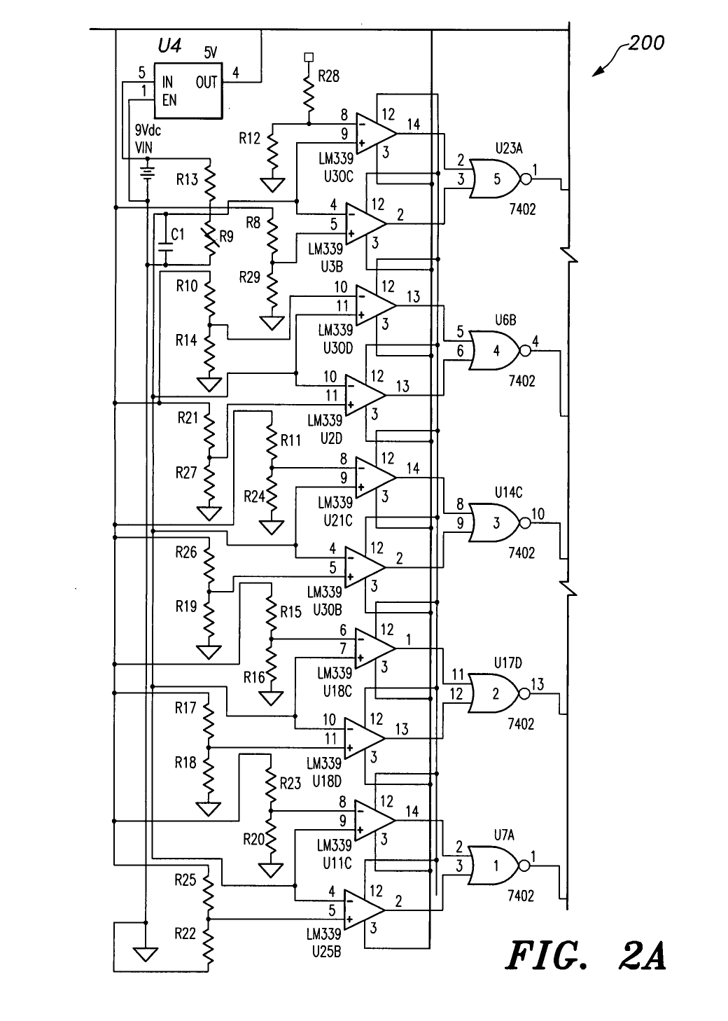

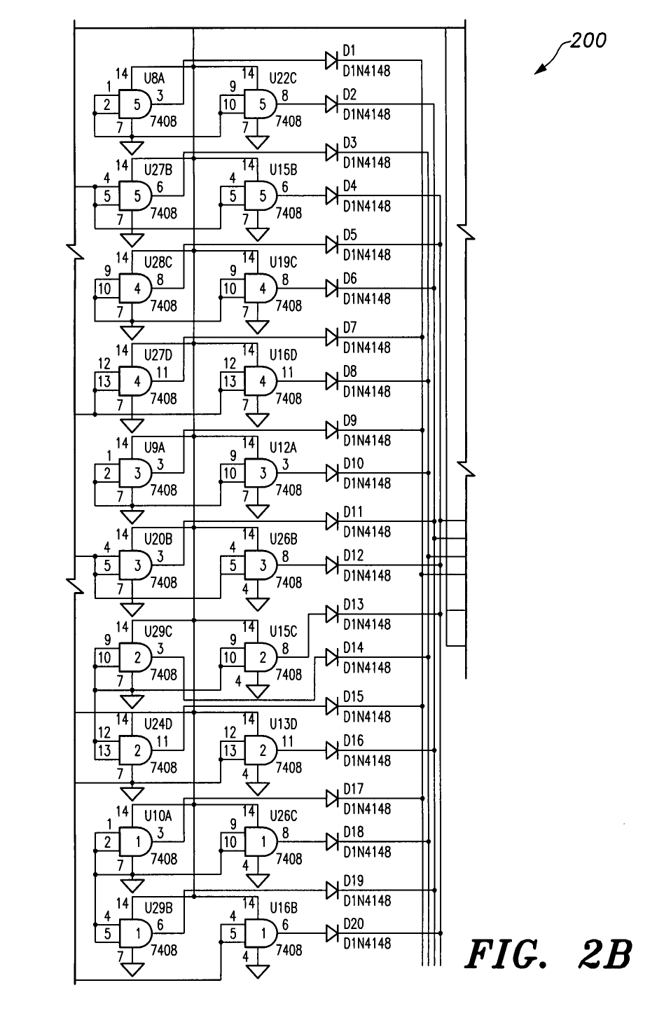

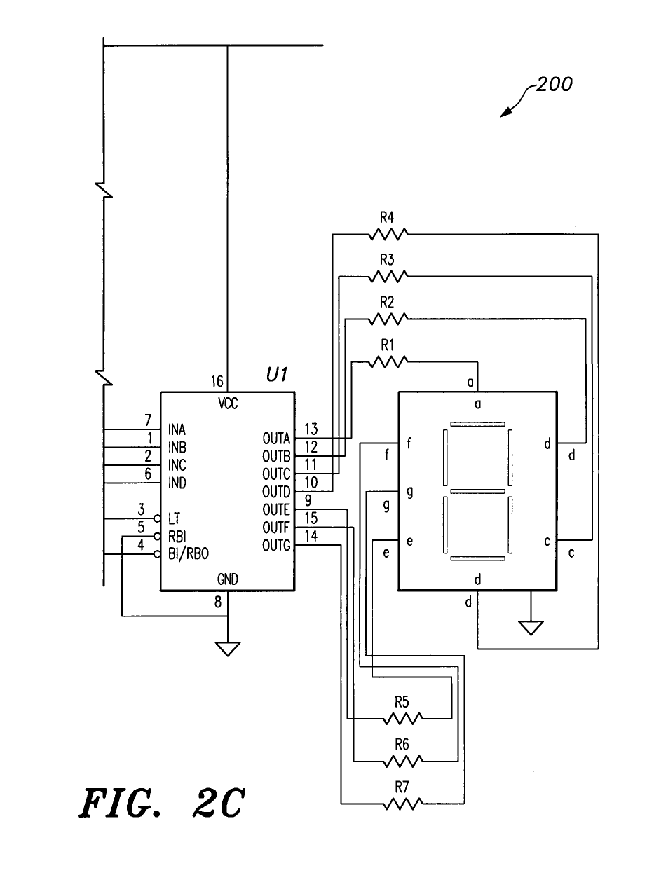

The basic logic incorporated in light detector 100 may be implemented in a number of alternative embodiments. For example, as shown in FIGS. 2A-2C, a control logic and driver circuit 200 for an alternative embodiment of the light detector comprises a number of analog and digital logic components that form a plurality of window comparators in order to provide light measurement according to a user-selected threshold.

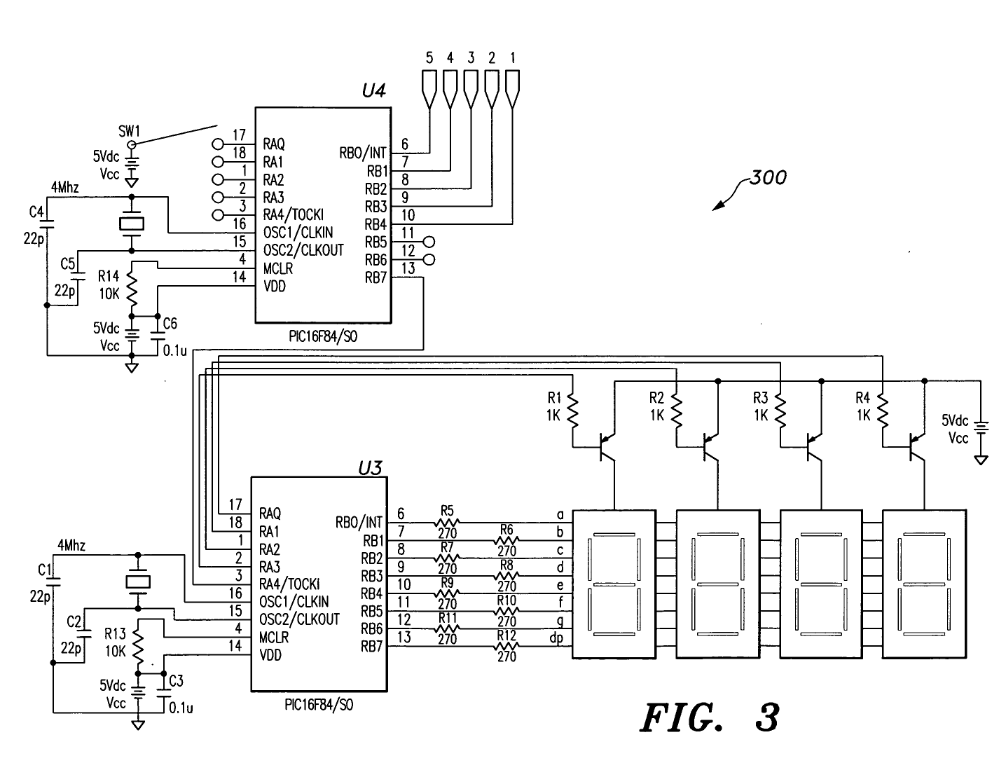

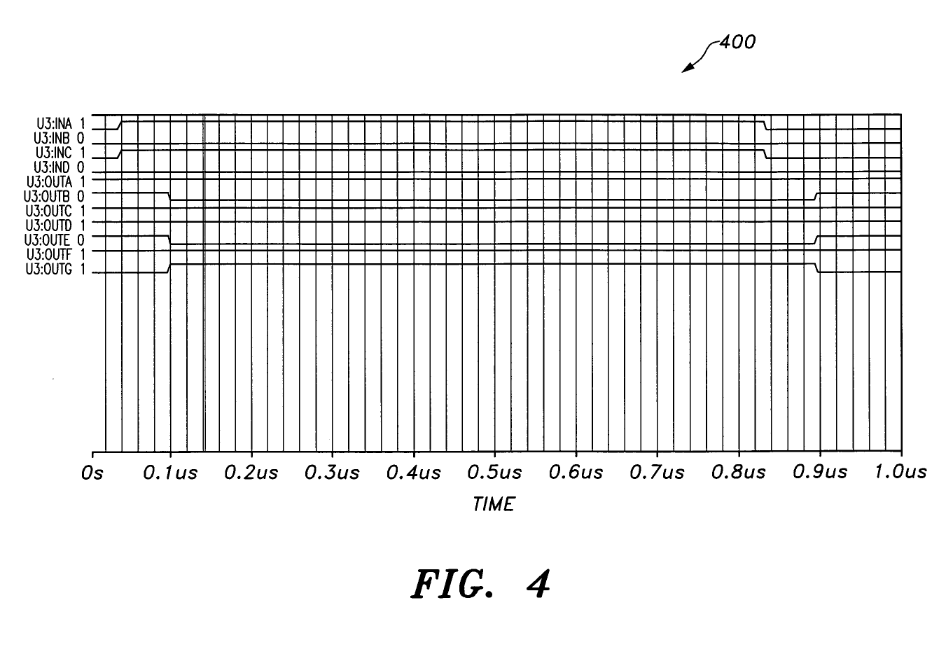

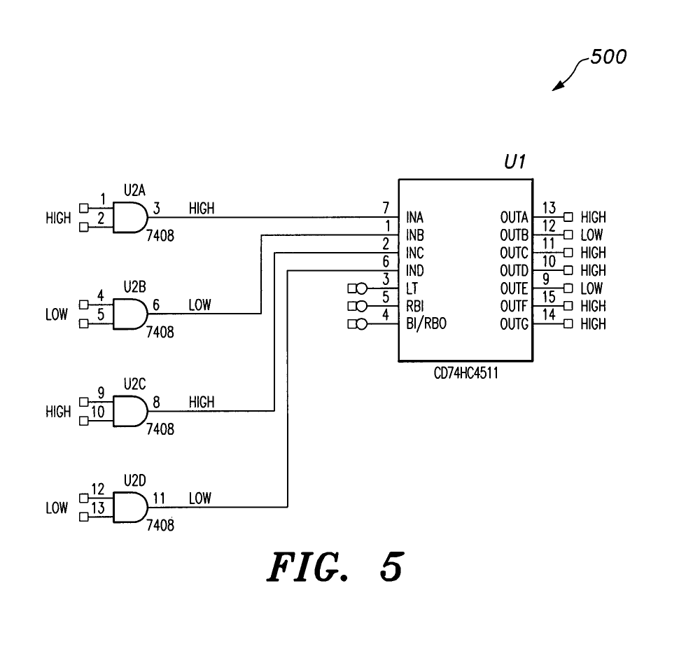

As shown in FIG. 3, the timer/counter circuit 300 comprises a pair of microcontrollers, designated as U3 and U4 in FIG. 3, that interface to the display circuitry. An exemplary timing diagram 400 of circuit FIG. 3 U3 is shown in FIG. 4. Driver circuitry 500, as shown in FIG. 5, may comprise a plurality of AND gates, designated as U2(A-D) in FIG. 5, driving a BCD-to-Seven segment decoder U1. As shown in FIG. 6, an event sequencer/decoder 600 can be implemented using a NOR gate U1A tied to AND gates U2A through U2D.

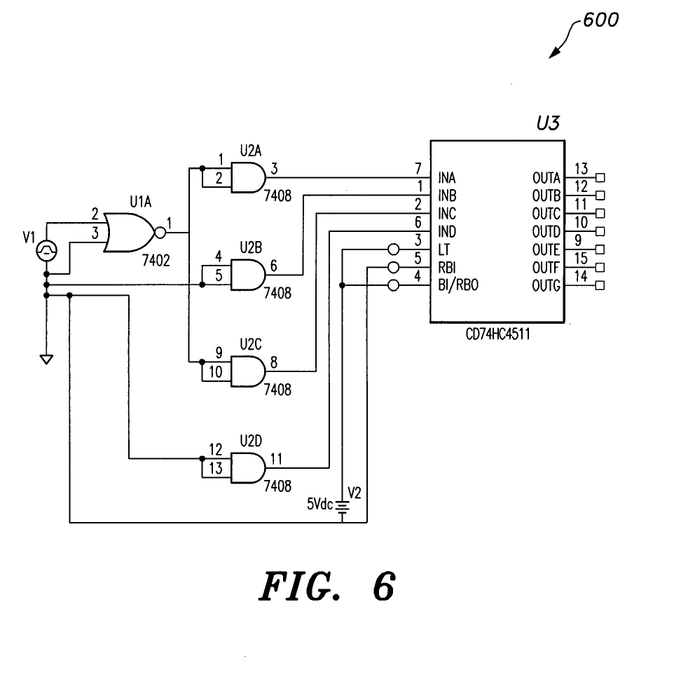

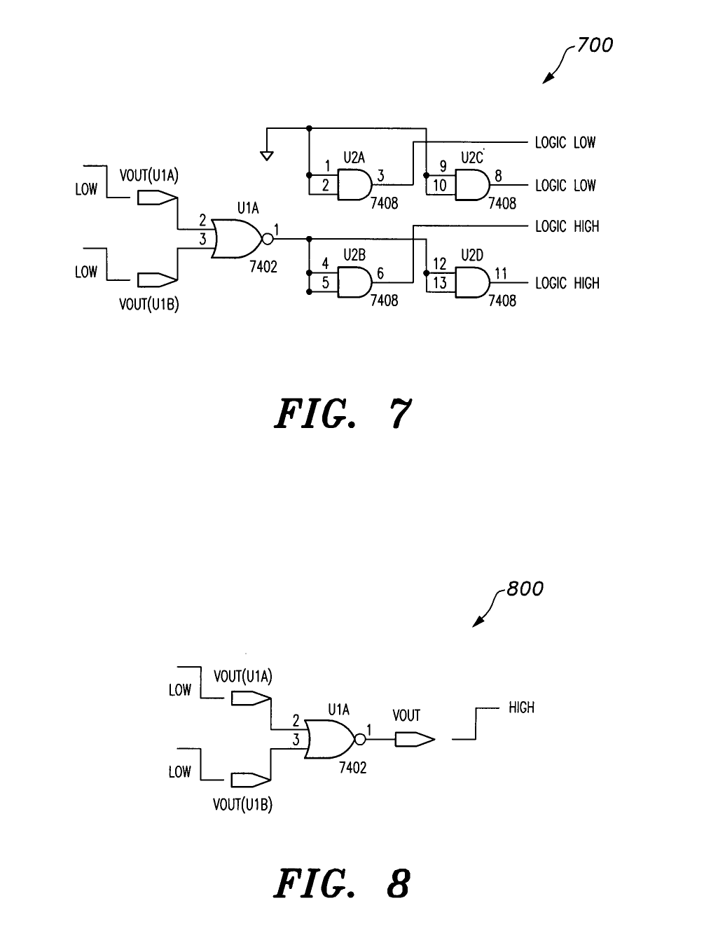

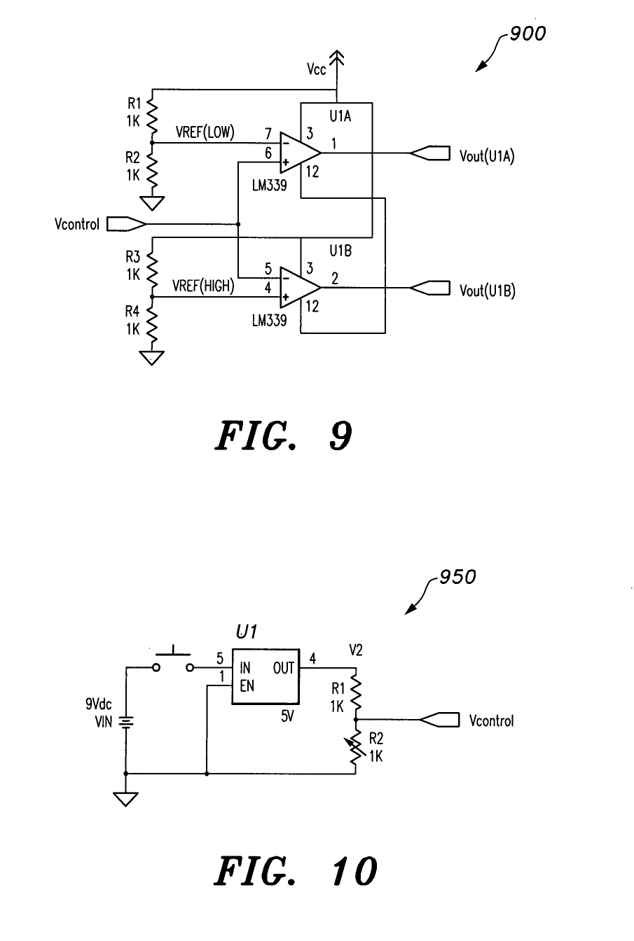

A latch decoder (U3 in FIG. 6) receives outputs from the AND gates U2A through U2D. As shown in FIG. 7, driver circuitry 700 comprises quadruple AND gates U2A-U2D, which may be configured to receive input from NOR gate U1A, or the like. As shown in FIG. 8, comparator driving circuitry 800 may comprise digital outputs Vₒᵤₜ driving NOR gate U1A. As shown in FIG. 9, a window comparator 900 comprises a pair of operational amplifiers U1A, U1B configured for control (V_{control}) and reference (V_{ref}) voltage inputs. A plurality of window comparators 900 is provided to reference a plurality of user selectable light threshold values (preferably from 0-5). As shown in FIG. 10, the control voltage V_{control} is produced by a 9-volt dc battery connected to a voltage regulator U1 in circuitry 950. Photo resistor R2 is configured in a voltage divider circuit with resistor R1 to detect light intensity. The related equation for V_{control} is as follows;

V_{control}=V2*(R2/(R2+R1)) (6)

Resistor R1 is chosen in order to scale the output of V_{control} to coincide with ΔR2. Referring again to FIG. 9, it should be understood that the window comparator comprises an inverting comparator (U1A in FIG. 9) in conjunction with a non-inverting comparator (U1B in FIG. 9). U1A is set up as an inverting comparator, meaning that when V_{control} exceeds V_{ref(Low)}, V_{out(U1A)} will switch from high to low. Conversely, U1B is set up as a non-inverting comparator, which means that when V_{control} exceeds V_{ref(High)}, V_{out(U1B)} will switch from low to high. Voltages V_{ref(Low)} and V_{ref(High)} are set up via the following equations:

V_{ref(Low)}=Vcc*(R2/(R2+R1)) (7)

V_{ref(High)}=Vcc*(R4/(R4+R3)) (8)

Referring again to FIGS. 7, 8 and 9, it should be well understood by those having ordinary skill in the art, that the AND gate truth table shown below in Table 1 results in the output of comparator driving circuitry 800 as shown in FIG. 8.

TABLE 1

| Input A | Input B | Output |
|---|---|---|
| L | L | L |
| L | H | L |
| H | L | L |
| H | H | H |

It is to be understood that the present invention is not limited to the embodiments described above, but encompasses any and all embodiments within the scope of the following claims.

We claim:

1. A light detector, comprising:
a photoelectric sensor generating an electrical signal proportional to an intensity of light contacting the photoelectric sensor;
a processor in electrical communication with the photoelectric sensor, the processor being programmed to compare the signal from the photoelectric sensor to a light intensity range selectable by a user;
a timing circuit having a counter incremented by the processor only when the signal generated by the photoelectric sensor corresponds to the light intensity range selected by the user, the processor having memory capable of storing the timing counter;
a wireless transceiver in operable communication with the processor in order to wirelessly communicate with a remote device for transmitting the timing counter and user-selected light intensity range to the remote device;
a display electrically configured to display output data from the processor, the output data including at least the timing counter; and
wherein the amount of time that light contacting the photoelectric sensor is within the light intensity range selected by the user is stored, displayed, and transmitted to the remote device.

2. The light detector according to claim 1, wherein the light intensity range has a lower threshold limit.

3. The light detector according to claim 1, wherein the light intensity range has a lower threshold limit and an upper threshold limit.

4. The light detector according to claim 1, wherein the photoelectric sensor comprises a photoresistor.

5. The light detector according to claim 1, wherein the processor is a microcontroller unit.

6. The light detector according to claim 1, wherein output data from the processor to the display further comprises the user-selected light intensity range.

7. The light detector according to claim 1, further comprising means for programming the processor.

8. The light detector according to claim 1, further comprising: a set/run switch having a set position and a run position, said processor being put in a mode for setting user-selectable light intensity range entries when the set/run switch is in the set position, said processor being put in a real-time operational mode when the set/run switch is in the run position.

9. The light detector according to claim 8, further comprising an increment switch for incrementing a user-selectable light intensity range value when the set/run switch is in the set position.

10. The light detector according to claim 8, further comprising a decrement switch for decrementing a user-selectable light intensity range value when the set/run switch is in the set position.

11. The light detector according to claim 1, wherein the user selectable light intensity range value is an integer between zero (0) and five (5) inclusive.

12. The light detector according to claim 1, wherein the timing counter has a value ranging from 00 hours, 00 minutes, 00 seconds to a predetermined maximum number of hours, minutes, and seconds.

13. The light detector according to claim 1, further comprising: means for switching power from an on-board power source to an external power source when the external power source is detected.

14. The light detector according to claim 1, where in the wireless transceiver is capable of operating over an Industrial Scientific Medical (ISM) radio frequency band.

15. The light detector according to claim 1, wherein the processor further comprises an analog-to-digital converter.

16. The light detector according to claim 15, wherein the analog-to-digital converter is capable of converting analog signals from the photoelectric sensor to a digital value having at least ten bits.

17. The light detector according to claim 15, wherein the photoelectric sensor further comprises a voltage divider circuit providing an analog input to the analog-to-digital converter of the processor.

18. A light detector, comprising:
a photoelectric sensor;
a display;
a time counter;
means for accepting a light intensity range selectable by a user;
means for outputting a light intensity value to the display detected by the photoelectric sensor;
means for comparing the user selectable light intensity range against the value detected by the photoelectric sensor
means for incrementing the time counter only if the value detected by the photoelectric sensor is within the user selectable light intensity range; and
means for displaying the time counter on the display;
wherein for any given period of use, the amount of time that light contacting the photoelectric sensor is within the light intensity range selected by the user is displayed.

19. The light detector according to claim 18, further comprising a wireless transceiver for operable communication between the light detector and a remote device.

20. The light detector according to claim 18, further comprising at least one data storage device for retention of light intensity and timing data.
